(19) United States
(12) Patent Application Publication
(10) Pub. No.: US 2021/0160160 A1
(43) Pub. Date: May 27, 2021

(54) METHOD, SYSTEM, READABLE STORAGE MEDIUM AND DEVICE FOR CONFIGURING ADAPTIVE NETWORK PRESSURE MEASUREMENT

(71) Applicants: Inventec (Pudong) Technology Corporation, Shanghai (CN); INVENTEC CORPORATION, Taipei (TW)

(72) Inventor: Yan LI, Tianjin (CN)

(73) Assignees: Inventec (Pudong) Technology Corporation, Shanghai (CN); INVENTEC CORPORATION, Taipei (TW)

(21) Appl. No.: 17/095,756

(22) Filed: Nov. 12, 2020

(30) Foreign Application Priority Data
Nov. 22, 2019 (CN) 201911156258X

(51) Int. Cl. H04L 12/26; H04L 12/721; H04L 12/717

(52) U.S. Cl. CPC H04L 43/0805; H04L 43/0882; H04L 45/42; H04L 45/38; H04L 43/16

(57) ABSTRACT

The disclosure provides a method, system, readable storage medium and device for configuring adaptive network pressure measurement. The c method for includes: obtaining the configuration information and attribute information of the network interfaces on the machine to be tested; performing pairing any two of the network interfaces in the linked status, so as to determine whether the two network interfaces are paired successfully, and if yes, removing the paired two network interfaces from the configuration information of the network interfaces, and continuing pairing any two of the remaining network interfaces; if not, pairing the two unpaired network interfaces separately with the remaining network interfaces to complete the pressure measurement of the network interfaces. The present disclosure performs the configuration for adaptive NIC pressure measurement according to automatic probing network deployment situation, which greatly alleviates the test engineer's work intensity and enhances the overall production and test efficiency.

### CROSS REFERENCE TO RELATED APPLICATION

This application claims the benefits of priority to Chinese Patent Application No. CN 201911156258X, entitled “Method, System, Readable Storage Medium and Device for Configuring Adaptive Network Pressure Measurement”, filed with CNIPA on Nov. 22, 2019, the contents of which are incorporated herein by reference in its entirety.

### BACKGROUND

### Field of Disclosure

The present disclosure belongs to the field of computer networks, and relates to a configuration method and system, in particular, to a method, system, readable storage medium and device for configuring adaptive network pressure measurement.

### Description of Related Arts

Network pressure measurement for network interface card (NIC) is an indispensable link in the server manufacturing process. Servers generally have many NICs, so there are a lot of physical units that need to be tested. If all NIC ports are interconnected via switch, the factory will need to invest significant cost to purchase switch for mass production. Therefore, in general, the test for NIC in the mass production stage is performed by directly connecting ports of NIC to each other. FIG. 1 shows a topology diagram of a conventional configuration of a server.

The content and method for measuring server NIC port often need to be carefully designed, otherwise enormous cost waste will be caused. Subsequently, according to the designed deployment method, front-line test engineers are required to manually edit the relevant configuration files. The configuration method of this test content is generally very complicated, and special test configuration is needed depending on the specific model and the operating system(OS) environment used for testing. It is a lot of work for front-line test engineers, and is a high technical threshold.

Therefore, providing a configuration method, system, readable storage medium and device for adaptive network pressure measurement, so as to solve drawbacks in the existing technology such as manually editing the configuration method of network pressure measurement, which increases the work intensity of test engineers, and reduces the production and test efficiency, has become an urgent technical problem in this field.

### SUMMARY

In view of the drawbacks of the existing technology mentioned above, the present disclosure provides a configuration method, system, readable storage medium and device for adaptive network pressure measurement, so as to solve the problems such as the need to manually edit the configuration method of network pressure measurement, the increase in the work intensity of test engineers, and the reduction in the production and test efficiency.

In one aspect, the present disclosure provides a method for configuring adaptive network pressure measurement applicable to the machine to be tested. The method includes: obtaining the configuration information and attribute information of the network interfaces on the machine to be tested; pairing any two of the network interfaces in the linked status, so as to determine whether the two network interfaces are paired successfully, if yes, removing the paired two network interfaces from the configuration information of the network interfaces, and continuing pairing any two of the remaining network interfaces; if not, pairing the two unpaired network interfaces separately with the remaining network interfaces to complete the pressure measurement of the network interfaces.

In an embodiment of the present disclosure, the attribute information of the network interfaces includes the types of the network interfaces, the maximum speed of the network interfaces, the current link speed of the network interfaces, and/or the current link status of the network interfaces.

In an embodiment of the present disclosure, the method further includes: removing the unlinked network interfaces from the configuration information of the network interfaces according to the current link status of the network interfaces.

In an embodiment of the present disclosure, after removing the unlinked network interfaces from the configuration information of the network interfaces, the method further includes: according to the similarities and differences of the types, maximum speed, current link speed of the network interfaces, the network interfaces with the same types, maximum speed, current link speed are grouped as a queue to be paired.

In an embodiment of the present disclosure, pairing any two of the network interfaces in the linked status so as to determine whether the two network interfaces are paired successfully includes: selecting any two network interfaces from the queue to be paired, taking the two network interfaces as a pair for bidirectional packet hedging; after hedging, according to the variation of transmitting packet and receiving packet of the two network interfaces, determining whether the two network interfaces are paired successfully; the variation of transmitting packet and receiving packet of the two network interfaces is the increasing amplitude of the transmitting packet and receiving packet.

In an embodiment of the present disclosure, selecting any two network interfaces from the queue to be paired, taking the two network interfaces as a pair for bidirectional packet hedging includes: defining a first network interface as a data transmitting end and a second network interface as a data receiving end; collecting the increasing amplitude of the transmitting packet of the first network interface that acts as a data transmitting end and the increasing amplitude of the receiving packet of the second network interface that acts as a data receiving end; defining the first network interface as a data receiving end and the second network interface as a data transmitting end; collecting the increasing amplitude of the transmitting packet of the second network interface that acts as a data transmitting end and the increasing amplitude of the receiving packet of the first network interface that acts as a data receiving end.

In an embodiment of the present disclosure, when the increasing amplitude of the transmitting packet of the first network interface that acts as a data transmitting end is equal to the increasing amplitude of the receiving packet of the second network interface that acts as a data receiving end; and the increasing amplitude of the transmitting packet of the second network interface that acts as a data transmitting end is equal to the increasing amplitude of the receiving packet of the first network interface that acts as a data receiving end, it is determined that the two network interfaces have been paired successfully.

In a second aspect, the present disclosure provides a system for configuring adaptive network pressure measurement, applicable to the machine to be tested. The system includes: an obtaining module, obtaining the configuration information and attribute information of the network interfaces on the machine to be tested; a pressure measurement module, pairing any two of the network interfaces in the linked status, so as to determine whether the two network interfaces are paired successfully, and if yes, removing the paired two network interfaces from the configuration information of the network interfaces, and continuing pairing any two of the remaining network interfaces; if not, pairing the two unpaired network interfaces separately with the remaining network interfaces to complete the pressure measurement of the network interfaces.

In a third aspect, the present disclosure provides a readable storage medium, containing a computer program. When executed by a processor, the computer program causes the processor to perform the method for configuring adaptive network pressure measurement.

In a fourth aspect, the present disclosure provides a device, including: a processor and a memory; the memory is configured to store a computer program, and the processor is configured to execute the computer program stored in the memory, so that the device performs the method for configuring adaptive network pressure measurement.

As described above, the method, system, readable storage medium, and device for configuring adaptive network pressure measurement according to the present disclosure have the following beneficial effects:

The method, system, readable storage medium, and device for configuring adaptive network pressure measurement of the present disclosure performs configuration for adaptive NIC pressure measurement according to automatic probing network deployment situation, which greatly alleviates the test engineer's work intensity and enhances the overall production and test efficiency.

### BRIEF DESCRIPTION OF THE DRAWINGS

FIG. 1 shows an example diagram of a conventional configuration topology of a server.

FIG. 2 shows a schematic diagram of a server according to the present disclosure.

FIG. 3A is a schematic flowchart of a configuration method for the adaptive network pressure measurement in an embodiment of the present disclosure.

FIG. 3B is a flowchart of S33 in the configuration method of the adaptive network pressure measurement according to the present disclosure.

FIG. 3C is a flowchart of S34 in the configuration method of the adaptive network pressure measurement according to the present disclosure.

FIG. 4 is a schematic diagram of a configuration system for an adaptive network pressure measurement in an embodiment of the present disclosure.

FIG. 5 shows a schematic diagram of a device according to the present disclosure.

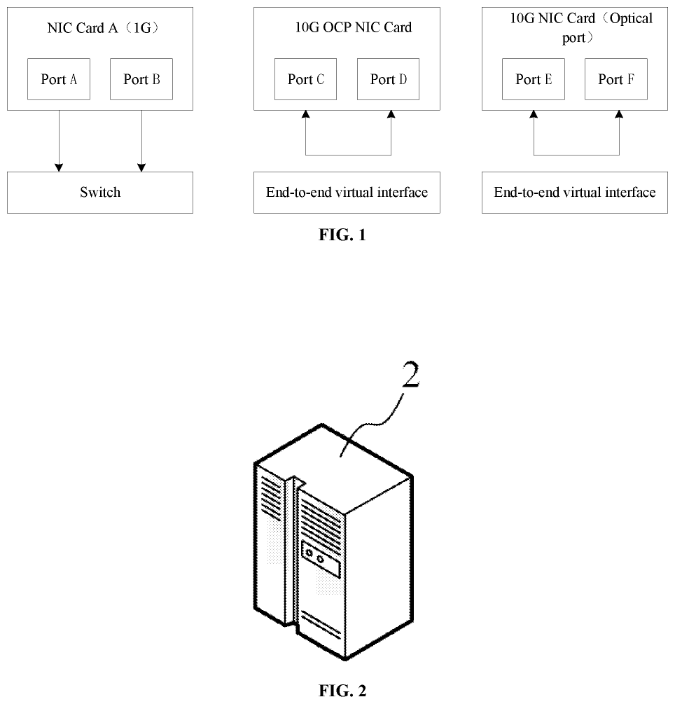

### DESCRIPTION OF REFERENCE NUMERALS

| | |
|---|---|
| 2 | Server |
| 4 | System for configuring adaptive |
| | network pressure measurement |
| 41 | Obtaining module |
| 42 | Grouping module |
| 43 | Pressure measurement module |
| 44 | Result forming module |
| 5 | Device |
| 51 | Processor |
| 52 | Memory |
| 53 | Transceiver |
| 54 | Communication interface |
| 55 | System bus |
| S31~S37 | Operations |
| S331~S332 | Operations |
| S341~S347 | Operations |

### DETAILED DESCRIPTION OF THE PREFERRED EMBODIMENTS

The implementation mode of the present disclosure will be described below through specific embodiments. Those skilled in the art can easily understand other advantages and effects of the present disclosure according to contents disclosed by the specification. The present disclosure can also be implemented or applied through other different specific implementation modes. Various modifications or changes can also be made to all details in the specification based on different points of view and applications without departing from the spirit of the present disclosure. It needs to be stated that the following embodiments and the features in the embodiments can be combined with one another under the situation of no conflict.

It needs to be stated that the drawings provided in the following embodiments are just used for schematically describing the basic concept of the present disclosure, thus only illustrating components only related to the present disclosure and are not drawn according to the numbers, shapes and sizes of components during actual implementation, the configuration, number and scale of each component during the actual implementation thereof may be freely changed, and the component layout configuration thereof may be more complicated.

### Embodiment 1

The present embodiment provides a method for configuring adaptive network pressure measurement, which is applicable to the machine to be tested. The method includes:

obtaining the configuration information of the network interfaces on the machine to be tested;

pairing any two of the network interfaces in a link status, so as to determine whether the two network interfaces are paired successfully. If yes, removing the paired two network interfaces from the configuration information of the network interfaces, and continuing pairing any two of the remaining network interfaces. If not, pairing the two unpaired network interfaces separately with the remaining network interfaces to complete a pressure measurement of the network interfaces.

The configuration method of adaptive network pressure measurement provided in this embodiment will be described in detail below with reference to the drawings. Configuration method of adaptive network pressure measurement described in this embodiment is applicable to the machine to be tested, such as the server 2 shown in FIG. 2.

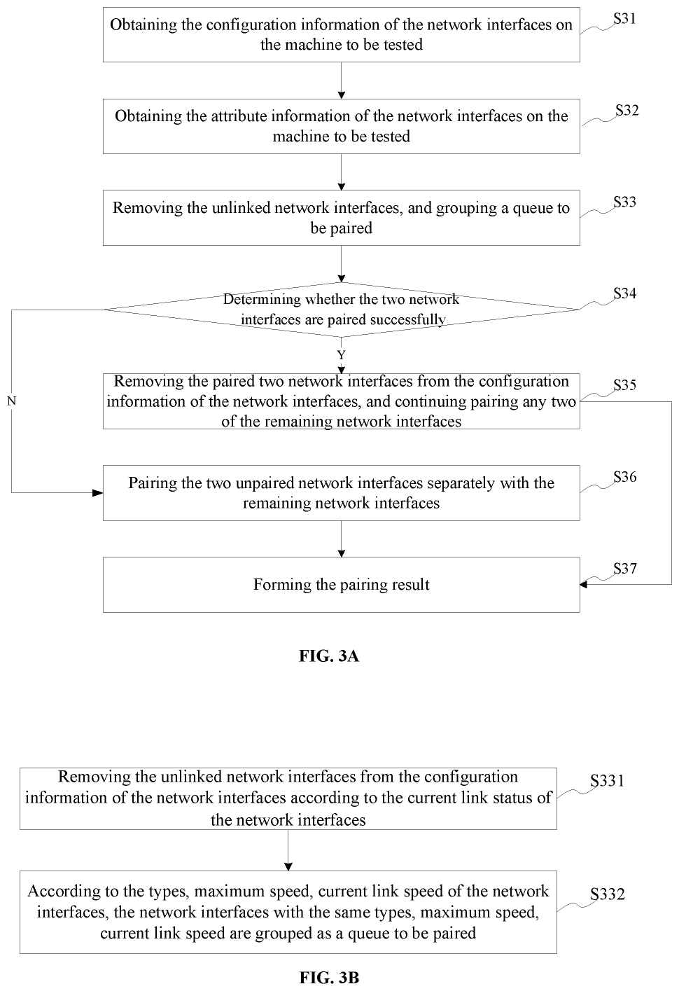

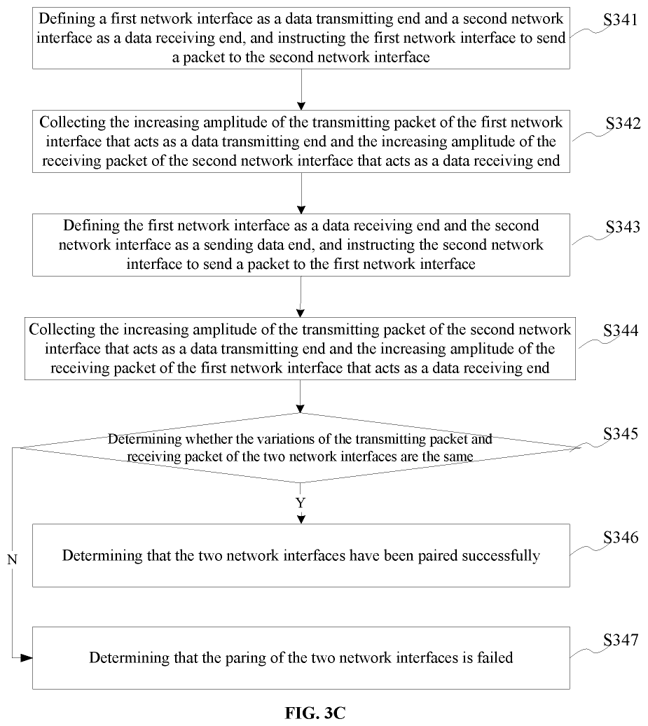

Referring to FIG. 3A, FIG. 3A is a flowchart of a method for configuring the adaptive network pressure measurement in an embodiment. As shown in FIG. 3A, the method for configuring the adaptive network pressure measurement includes the following steps:

S31, obtaining the configuration information of the network interfaces on the machine to be tested;

In this embodiment, the configuration information of all the network interfaces on the several machines to be tested is obtained by sending a first obtaining instruction. The configuration information of the network interfaces includes the number of the network interfaces, for example, eth0, eth1, eth2, eth3. In this embodiment, the configuration information of the network interfaces does not include a loopback interface. The first obtaining instruction adopts an ifconfig instruction in an exemplary embodiment.

S32, obtaining the attribute information of the network interfaces on the machine to be tested;

In this embodiment, the attribute information of the network interfaces is obtained by sending a second obtaining instruction. In an exemplary embodiment, the second obtaining instruction adopts an ethtool instruction. The attribute information of the network interfaces includes the types of the network interfaces (supported ports, typically optical or electrical port), the maximum speed of the network interfaces (maxspeed), the current link speed of the network interfaces (link speed), and/or the current link status of the network interfaces (link status), etc.

S33, removing the unlinked network interfaces, and grouping the linked network interfaces to be paired.

Referring to FIG. 3B, which is a flowchart of S33. As shown in FIG. 3B, S33 includes the following steps:

S331, removing the unlinked network interfaces from the configuration information of the network interfaces according to the current link status of the network interfaces (link status). The network interface with a link status of no does not have any physical connection, there is no need to participate in the package test.

S332, according to the types, maximum speed, current link speed of the network interfaces, the network interfaces with the same types, maximum speed, current link speed are grouped as a queue to be paired.

For example, among eth0, eth1, eth2 and eth3, grouping eth0, eth1 and eth2 with the same above-mentioned attributes as the queue to be paired.

S34, performing pairing any two of the network interfaces in the link status, so as to determine whether the two network interfaces are paired successfully. If yes, performing S35; if not, performing S36. That is, pairing the two unpaired network interfaces separately with the remaining network interfaces to complete the pressure measurement of the network interfaces.

Specifically, S34 includes:

selecting any two network interfaces from the queue to be paired, and taking the two network interfaces as a pair for bidirectional packet hedging;

For example, taking network interfaces eth0 and eth1 as a pair to perform bidirectional packet hedging.

after hedging, according to the variation of transmitting packet and receiving packet of the two network interfaces, determining whether the two network interfaces are paired successfully; the variation of transmitting packet and receiving packet of the two network interfaces is the increasing amplitude of the transmitting packet and receiving packet.

When the increasing amplitude of the transmitting packet of the network interface that acts as a data transmitting end is equal to the increasing amplitude of the receiving packet of the network interface that acts as a data receiving end;

and the increasing amplitude of the transmitting packet of the network interface that acts as a data transmitting end is equal to the increasing amplitude of the receiving packet of the network interface that acts as a data receiving end, determining that the two network interfaces have been paired successfully.

Referring to FIG. 3C, which is a flowchart of S34. As shown in FIG. 3C, S34 includes the following steps:

S341, defining a first network interface as a data transmitting end and a second network interface as a data receiving end.

For example, defining the network interface eth0 as a data transmitting end, and the network interface eth1 as a data receiving end.

S342, after using a Linux pktgen module for a certain number of packet hedging, collecting the increasing amplitude(eth0 TX) of the transmitting packet of the first network interface that acts as a data transmitting end and the increasing amplitude(eth1 RX) of the receiving packet of the second network interface that acts as a data receiving end.

S343, defining the first network interface as a data receiving end and the second network interface as a sending data end.

For example, defining the network interface eth1 as a data transmitting end, and the network interface eth0 as a data receiving end.

S344, collecting the increasing amplitude(eth1 TX) of the transmitting packet of the second network interface that acts as a data transmitting end and the increasing amplitude(eth0 RX) of the receiving packet of the first network interface that acts as a data receiving end.

S345, after hedging, according to the variation of transmitting packet and receiving packet of the two network interfaces, determining whether the two network interfaces are paired successfully; if yes, performing S346; if not, performing S347. In this embodiment, the variation of transmitting packet and receiving packet of the two network interfaces is the increasing amplitude of the transmitting packet and receiving packet.

S346, when the increasing amplitude(eth0 TX) of the transmitting packet of the first network interface that acts as a data transmitting end is basically the same as the increasing amplitude(eth1 RX) of the receiving packet of the second network interface that acts as a data receiving end; meanwhile, the increasing amplitude(eth1 TX) of the transmitting packet of the second network interface that acts as a data transmitting end is basically the same as the increasing amplitude(eth0 RX) of the receiving packet of the first network interface that acts as a data receiving end, it is determined that the two network interfaces have been paired successfully.

S347, if the increasing amplitude of the transmitting packet is different from that of the receiving packet, it is determined that the paring of the two network interfaces is failed.

Specifically, if the increasing amplitude of eth0 TX is basically the same as that of eth1 RX, and the increasing amplitude of eth1 TX is basically the same as that of eth0 RX, it is determined that the network interfaces eth0 and eth1 are in a link status and the pairing is successful.

S35, removing the paired two network interfaces from the configuration information of the network interfaces, and continuing pairing any two of the remaining network interfaces.

For example, removing network interfaces eth0 and eth1 from the queue to be paired. Only the network interface eth2 does not need to be further paired.

S36, pairing the two unpaired network interfaces separately with the remaining network interfaces to complete the pressure measurement.

For example, if network interfaces eth0 and eth1 are not paired successfully, network interfaces eth0 is paired with eth2 or network interfaces eth1 is paired with eth2.

Specifically, defining the network interface eth0 as a data transmitting end, and the network interface eth2 as a data receiving end.

After using a Linux pktgen module for a certain number of packet hedging, collecting the increasing amplitude(eth0 TX) of the transmitting packet of one network interface that acts as a data transmitting end and the increasing amplitude(eth2 RX) of the receiving packet of another network interface that acts as a data receiving end;

defining the network interface eth2 as a data transmitting end, and the network interface eth0 as a data receiving end.

collecting the increasing amplitude(eth2 TX) of the transmitting packet of the network interface that acts as a data transmitting end and the increasing amplitude(eth0 RX) of the receiving packet of the network interface that acts as a data receiving end.

If the increasing amplitude of eth0 TX is basically the same as that of eth2 RX, and the increasing amplitude of eth2 TX is basically the same as that of eth0 RX, it is determined that the network interfaces eth0 and eth2 are in a link status and the pairing is successful.

The pairing process for network interfaces eth1 and eth2 is the same.

S37, after the pairing of all network interfaces is completed, forming the pairing result, and transmitting the pairing result to the NIC pressure measurement program, so that the NIC pressure measurement program can implement the NIC pressure measurement of adaptive pairing without configuration according to the pairing result.

The method for configuring adaptive network pressure measurement of the present embodiment performs configuration for adaptive NIC pressure measurement according to automatic probing network deployment situation. The method greatly alleviates the test engineer's work intensity and enhances the overall production and test efficiency.

The present embodiment further provides a readable storage medium (also called computer readable storage medium), containing a computer program. When executed by a processor, the processor performs the method for configuring adaptive network pressure measurement.

Those of ordinary skill will understand computer readable storage medium: all or part of the steps to implement the various method embodiments described above may be accomplished by hardware associated with a computer program. The aforementioned computer program may be stored in a computer readable storage medium. The program, when executed, performs the steps including the above method embodiments. The aforementioned storage medium includes various mediums that may store program codes, such as a ROM, a RAM, a magnetic disk, or an optical disk.

### Embodiment 2

The present embodiment provides a system for configuring adaptive network pressure measurement, which is applicable to the machine to be tested. The system includes:

an obtaining module, obtaining the configuration information and attribute information of the network interfaces on the machine to be tested;

a pressure measurement module, which is used to perform pairing any two of the network interfaces in the link status, so as to determine whether the two network interfaces are paired successfully. If yes, removing the paired two network interfaces from the configuration information of the network interfaces, and continuing pairing any two of the remaining network interfaces. If not, pairing the two unpaired network interfaces separately with the remaining network interfaces to complete a pressure measurement of the network interfaces.

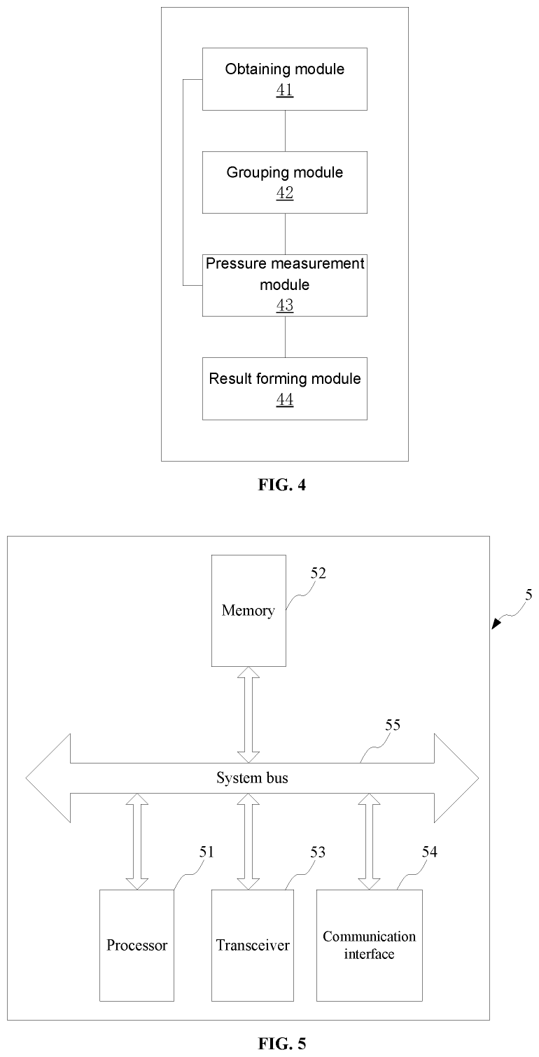

The system for configuring adaptive network pressure measurement provided in this embodiment will be described in detail below with reference to the drawings. Referring to FIG. 4, FIG. 4 is a schematic diagram of a c system for configuring an adaptive network pressure measurement in an embodiment. As shown in FIG. 4, the system 4 for configuring the adaptive network pressure measurement includes an obtaining module 41, a grouping module 42, a pressure measurement module 43 and a result forming module 44.

The obtaining module 41 obtains the configuration information and attribute information of the network interfaces on the machine to be tested.

In this embodiment, the configuration information of all the network interfaces on the several machines to be tested is obtained by sending a first obtaining instruction. The configuration information of the network interfaces includes the number of the network interfaces, for example, eth0, eth1, eth2, eth3. In this embodiment, the configuration information of the network interfaces does not include a loopback interface. The first obtaining instruction adopts an ifconfig instruction in practical application.

In this embodiment, the attribute information of the network interfaces is obtained by sending a second obtaining instruction. In an exemplary embodiment, the second obtaining instruction adopts an ethtool instruction. The attribute information of the network interfaces includes the types of the network interfaces (supported ports, typically optical or electrical port), the maximum speed of the network interfaces (maxspeed), the current link speed of the network interfaces (link speed), and/or the current link status of the network interfaces (link status), etc.

The grouping module 42 coupled to the obtaining module 41 is configured to remove the network interface in an unlinked status and group a queue to be paired.

Specifically, the grouping module 42 removes the unlinked network interfaces from the configuration information of the network interfaces according to the current link status of the network interfaces (link status). The network interfaces with the same types, maximum speed, current link speed are grouped as a queue to be paired.

The pressure measurement module 43 coupled to the obtaining module 41 and the grouping module 42 performs pairing any two of the network interfaces in the linked status, so as to determine whether the two network interfaces are paired successfully. If yes, performing S35. If not, performing S36, that is, pairing the two unpaired network interfaces separately with the remaining network interfaces to complete the pressure measurement of the network interfaces.

Specifically, the pressure measurement module 43 selects any two network interfaces from the queue to be paired, and takes the two network interfaces as a pair for bidirectional packet hedging. After hedging, according to the variation of transmitting packet and receiving packet of the two network interfaces, determines whether the two network interfaces are paired successfully; the variation of transmitting packet and receiving packet of the two network interfaces is the increase amplitude of the transmitting packet and receiving packet. When the increasing amplitude of the transmitting packet of one network interface that acts as a data transmitting end is equal to the increasing amplitude of the receiving packet of another network interface that acts as a data receiving end; and the increasing amplitude of the transmitting packet of another network interface that acts as a data transmitting end is equal to the increasing amplitude of the receiving packet of one network interface that acts as a data receiving end, determining that the two network interfaces have been paired successfully.

Further, the pressure measurement module 43 defines the first network interface as a data transmitting end, and the second network interface as a data receiving end. After using a Linux pktgen module for a certain number of packet hedging, collecting the increasing amplitude of the transmitting packet of the first network interface that acts as a data transmitting end and the increasing amplitude of the receiving packet of the second network interface that acts as a data receiving end. Defining the first network interface as a data receiving end and the second network interface as a transmitting data end. Collecting the increasing amplitude of the transmitting packet of the second network interface that acts as a data transmitting end and the increasing amplitude of the receiving packet of the first network interface that acts as a data receiving end. After hedging, according to the variation of transmitting packet and receiving packet of the first and second network interfaces, determining whether the two network interfaces are paired successfully. If yes, it is determined that the two network interfaces have been paired successfully. If not, it is determined that the paring of the two network interfaces have failed. In this embodiment, the variation of transmitting packet and receiving packet of the two network interfaces is the increasing amplitude of the transmitting packet and receiving packet.

When the increasing amplitude of the transmitting packet of network interface that acts as a data transmitting end is basically the same as the increasing amplitude of the receiving packet of network interface that acts as a data receiving end; meanwhile, the increasing amplitude of the transmitting packet of network interface that acts as a data transmitting end is basically the same as the increasing amplitude of the receiving packet of network interface that acts as a data receiving end, it is determined that the two network interfaces have been paired successfully. If the increasing amplitude of the transmitting packet and the receiving packet is different, it is determined that the paring of the two network interfaces have failed.

The pressure measurement module 43 is further used to remove the paired two network interfaces from the configuration information of the network interfaces, and continue pairing any two of the remaining network interfaces.

The pressure measurement module 43 further pairs the two unpaired network interfaces separately with the remaining network interfaces to complete the pressure measurement.

The result forming module 44 coupled to the pressure measurement module 43 is used to form the pairing result after the pressure measurement module 43 has completed pairing of all network interfaces, and transmit the pairing result to the NIC pressure measurement program, so that the NIC pressure measurement program can implement the NIC pressure measurement of adaptive pairing without configuration according to the pairing result.

It should be noted that the division of each module of the above system is only a division of logical functions. In actual implementation, the modules may be integrated into one physical entity in whole or in part, or may be physically separated. And these modules may all be implemented in the form of processing component calling by software, or they may all be implemented in the form of hardware. It is also possible that some modules are implemented in the form of processing component calling by software, and some modules are implemented in the form of hardware. For example, the pressure measurement module may be a separate processing component, or may be integrated into a chip of the above-mentioned system. In addition, the pressure measurement module may also be stored in the memory of the above system in the form of a program code. The function of the above module is called and executed by a processing component of the above system. The implementation of other modules is similar. All or part of these modules may be integrated or implemented independently. The processing elements described herein may be an integrated circuit with signal processing capabilities. In the implementation process, each step of the above method or each of the above modules may be completed by an integrated logic circuit of hardware in the processor component or instruction in a form of software. The above modules may be one or more integrated circuits configured to implement the above method, such as one or more Application Specific Integrated Circuits (ASICs), one or more Digital Signal Processors (DSPs), or one or more Field Programmable Gate Arrays (FPGAs). When one of the above modules is implemented in the form of calling program codes by a processing component, the processing component may be a general processor, such as a Central Processing Unit (CPU) or other processors that may call program codes. These modules may be integrated and implemented in the form of a system-on-a-chip (SOC).

### Embodiment 3

This embodiment provides a device. Referring to FIG. 5, which is a schematic diagram the device. As shown in FIG. 5, the device 5 includes a processor 51, a memory 52, a transceiver 53, a communication interface 54 or/and a system bus 55. The memory 52 and the communication interface 54 connect to the processor 51 and the transceiver 53 through the system bus 55. The memory 52 is used to store computer programs. The communication interface 54 is used to communicate with other devices. The processor 51 and the transceiver 53 are used to execute computer programs, so that the devices implement steps of the method for configuring adaptive network pressure measurement as described in embodiment 1.

The system bus mentioned above may be a Peripheral Component Interconnect (PCI) bus or an Extended Industry Standard Architecture (EISA) bus, etc. The system bus can be divided into an address bus, data bus, control bus and so on. For convenience of representation, only a thick line is used in the figure, but it does not mean that there is only one bus or one type of bus. The communication interface is used to implement communication between the database access device and other devices (such as a client, a read-write library, and a read-only library). The memory may include Random Access Memory (RAM), or may also include non-volatile memory, such as at least one disk memory.

The above processor may be a general processor, including a Central Processing Unit (CPU), a Network Processor (NP), etc; it may also be a Digital Signal Processing (DSP), Application Specific Integrated Circuit (ASIC), Field Programmable Gate Array (FPGA) or other programmable logic devices, discrete gate or transistor logic devices, discrete hardware components.

The protection scope of the configuration method for adaptive network pressure measurement as described in the present disclosure is not limited to the sequence of steps listed in this embodiment. Any scheme realized by adding or subtracting steps or replacing steps of the existing techniques according to the principle of the present disclosure is included in the protection scope of the present disclosure.

The present disclosure also provides a configuration system for adaptive network pressure measurement. The configuration system for adaptive network pressure measurement may implement the configuration method for adaptive network pressure measurement as described in the present disclosure. However, the realizing device of the configuration method for adaptive network pressure measurement as described in the present disclosure is not limited to the structure of the configuration system of adaptive network pressure measurement as listed in this embodiment. Any structural deformation and replacement of existing techniques made according to the principle of the present disclosure are included in the protection scope of the present disclosure.

In summary, the method, system, readable storage medium, and device for configuring adaptive network pressure measurement according to the present disclosure performs adaptive NIC pressure measurement configuration according to automatic probing network deployment situation. The test engineers work intensity is greatly alleviated and the overall production and test efficiency are enhanced. The present disclosure effectively overcomes various shortcomings and has high industrial utilization value.

The above-mentioned embodiments are just used for exemplarily describing the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

What is claimed is:

1. A method for configuring adaptive network pressure measurement, applicable to a machine to be tested; the method comprises:
obtaining configuration information and attribute information of network interfaces on the machine to be tested;
pairing any two of the network interfaces in a linked status, so as to determine whether the two network interfaces are paired successfully, if yes, removing the paired two network interfaces from the configuration information of the network interfaces, and continuing pairing any two of the remaining network interfaces; if not, pairing the two unpaired network interfaces separately with the remaining network interfaces to complete a pressure measurement of the network interfaces.

2. The method for configuring adaptive network pressure measurement according to claim 1, wherein the attribute information of the network interfaces comprises types of the network interfaces, maximum speed of the network interfaces, current link speed of the network interfaces, and/or current link status of the network interfaces.

3. The method for configuring adaptive network pressure measurement according to claim 2, further comprising: removing the unlinked network interfaces from the configuration information of the network interfaces according to the current link status of the network interfaces.

4. The method for configuring adaptive network pressure measurement according to claim 3, wherein after removing the unlinked network interfaces from the configuration information of the network interfaces, the method further comprises: according to similarities and differences of the types, maximum speed and current link speed of the network interfaces, the network interfaces with a same type, maximum speed, current link speed are grouped as a queue to be paired.

5. The method for configuring adaptive network pressure measurement according to claim 4, wherein pairing any two of the network interfaces in the linked status, so as to determine whether the two network interfaces are paired successfully comprises:
selecting any two network interfaces from the queue to be paired, and taking the two network interfaces as a pair for bidirectional packet hedging;
after hedging, according to a variation of transmitting packet and receiving packet of the two network interfaces, determining whether the two network interfaces are paired successfully; the variation of transmitting packet and receiving packet of the two network interfaces is the increasing amplitude of the transmitting packet and receiving packet.

6. The method for configuring adaptive network pressure measurement according to claim 5, wherein selecting any two network interfaces from the queue to be paired, and taking the two network interfaces as a pair for bidirectional packet hedging comprises:
defining a first network interface as a data transmitting end and a second network interface as a data receiving end;
collecting an increasing amplitude of the transmitting packet of the first network interface that acts as a data transmitting end and an increasing amplitude of the receiving packet of the second network interface that acts as a data receiving end;
defining the first network interface as a data receiving end and the second network interface as a transmitting data end;
collecting an increasing amplitude of the transmitting packet of the second network interface that acts as a data transmitting end and an increasing amplitude of the receiving packet of the first network interface that acts as a data receiving end.

7. The method for configuring adaptive network pressure measurement according to claim 6, wherein:
when the increasing amplitude of the transmitting packet of the first network interface that acts as a data transmitting end is equal to the increasing amplitude of the receiving packet of second network interface that acts as a data receiving end;
and the increasing amplitude of the transmitting packet of the second network interface that acts as a data transmitting end is equal to the increasing amplitude of the receiving packet of the first network interface that acts as a data receiving end, it is determined that the two network interfaces have been paired successfully.

8. A system for configuring adaptive network pressure measurement, applicable to a machine to be tested; the system comprises:
an obtaining module, obtaining configuration information and attribute information of network interfaces on a machine to be tested;
a pressure measurement module, pairing any two of the network interfaces in a linked status, so as to determine whether the two network interfaces are paired successfully, if yes, removing the paired two network interfaces from the configuration information of the network interfaces, and continuing pairing any two of the remaining network interfaces; if not, pairing the two unpaired network interfaces separately with the remaining network interfaces to complete a pressure measurement of the network interfaces.

9. A readable storage medium, containing a computer program, wherein when executed by a processor, the computer program causes the processor to perform the method for configuring adaptive network pressure measurement according to claim 1.

10. A device, comprising: a processor and a memory;
the memory stores a computer program, and the processor executes the computer program stored in the memory, so that the device performs the method for configuring adaptive network pressure measurement according to claim 1.
